(19) United States
(12) Patent Application Publication
(10) Pub. No.: US 2008/0120157 A1
(43) Pub. Date: May 22, 2008

(54) Golf course tee-time management system

(76) Inventor: Jeffery H. Foster, Scottsdale, AZ (US)

Correspondence Address: MICHAEL WINFIELD GOLTRY, 4000 N. CENTRAL AVENUE, SUITE 1220, PHOENIX, AZ, 85012, US

(21) Appl. No.: 11/600,979

(22) Filed: Nov. 17, 2006

(51) Int. Cl. G06F 19/00

(52) U.S. Cl. 705/8

(57) ABSTRACT

A golf course tee-time management system including a data server coupled through the internet to a plurality of participating golf facilities. Each participating golf facility has interface software coupling the participating golf facility to the data server. The data server and the interface software are designed to provide tee-sheets in real time for each of the plurality of participating golf facilities. A web site is coupled to the data server and has associated software for displaying information on a remote PC about each of the plurality of participating golf facilities and the tee-sheets of each of the plurality of participating golf facilities including available tee-times.

### FIELD OF THE INVENTION

This invention generally relates to a management system for tee-times and more specifically to a web site tee-time management system.

### BACKGROUND OF THE INVENTION

At the present time golf has become a major attraction for a large variety of individuals. However, because of this attraction finding and reserving a tee-time at any desired golf facility has become very difficult, in many instances requiring great lead time in making the reservation.

Some prior art types of systems have attempted to solve this problem by providing user input modules that are distributed throughout a wide geographic area. These modules are coupled through an interface module to a plurality of individual golf course reservation systems. A golfer/user can make a reservation for a desired golf facility through one of the modules which, through the interface module, will receive acceptance of the tee time request. A major problem with this type of system is that the golfer/user must go to one of the input modules, which may not be very convenient. Further, the golfer/user cannot search a wide variety of golf facilities and determine where, specifically an opening is available at the precise time it is desired.

It would be highly advantageous, therefore, to remedy the foregoing and other deficiencies inherent in the prior art.

Accordingly, it is an object of the present invention to provide a new and improved golf course tee-time management system.

Another object of the invention is to provide a new and improved golf course tee-time management system that is convenient to golfer/users.

Another object of the invention is to provide a new and improved golf course tee-time management system that allows perusal of a wide variety of golf courses and a view of available tee-times for the golfer/user's choice.

### SUMMARY OF THE INVENTION

The above objects and others are realized in a golf course tee-time management system including a data server coupled through the internet to a plurality of participating golf facilities. Each participating golf facility has interface software coupling the participating golf facility to the data server. The data server and the interface software are designed to provide tee-sheets in real time for each of the plurality of participating golf facilities. A web site is coupled to the data server and has associated software for displaying information on a remote PC about each of the plurality of participating golf facilities and the tee-sheets of each of the plurality of participating golf facilities including available tee-times.

The above objects and others are further achieved through a method of operating a golf course tee-time management system including the steps of subscribing a plurality of participating golf facilities to the management system, providing each participating golf facility with interface software, and providing a data server and coupling the plurality of participating golf facilities to the data server through the internet and the interface software. The method further includes providing a web site coupled to the data server and available to PCs through the internet. Tee-sheets are communicated in real time from each of the participating golf facilities to the data server through the interface software at each participating golf facility and the tee-time availability at any selected participating golf facility is displayed on a remote PC on demand from the remote PC.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified block diagram of a golf course tee-time management system in accordance with the present invention; and

FIGS. 2-4 are views of various screens available to golfer/users of the system.

### DETAILED DESCRIPTION OF A PREFERRED EMBODIMENT

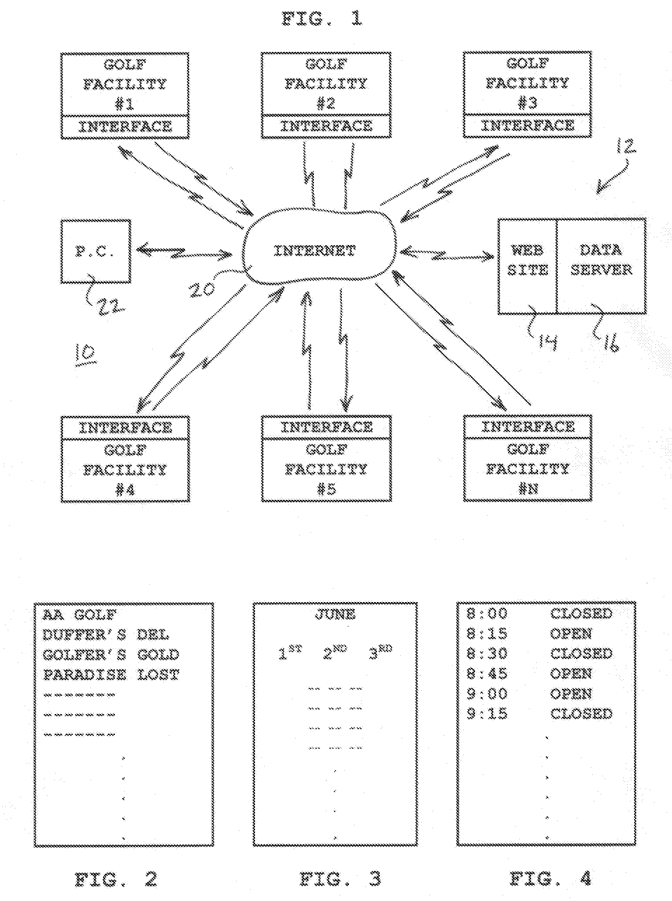

Turning now to the drawings, attention is first directed to FIG. 1 which illustrates a simplified block diagram of a golf course tee-time management system 10 in accordance with the present invention. System 10 includes an online tee-sheet provider 12 that includes a web site 14 with an associated data server 16. Web site 14 is preferably accessible through a popular internet 20, such as the world-wide-web (WWW), or any other convenient internet that is available to a desired area. Web site 14 is accessible online through internet 20 by any remote PC 22, such as a home or office PC accessible to a golfer/user. In this context, the term “remote PC” is intended to include any device capable of receiving messages and displaying information, such as a personal computer, a laptop, a smart phone, a cell phone, etc. The data available on web site 14 is provided in real-time by data server 16 which, in turn, receives tee-sheet data from individual golf course tee-sheet systems (herein designated golf facilities 1-N). Data server 16 collects and houses uploaded data from all participating golf facilities 1-N. Data is managed locally on data server 16 and updated as new information is uploaded. The complete library of available tee-times (tee-sheets) is current and live.

Each golf facility 1-N has an individual golf course reservation system that may or may not be peculiar to that specific golf facility. Dozens of reservation systems are available on the market and each golf facility 1-N may use anyone of these or any other software designed for the purpose. Each golf facility utilizes software or an interface supplied by the owner/operator of tee-sheet provider 12 which interfaces tee-sheet provider 12 with the reservation system used in each golf facility and allows each golf facility 1-N to communicate with data server 16 and vice versa.

During normal business, the individual software of each golf facility 1-N is used to schedule and book tee-times. The interface software monitors this activity and when changes are made (e.g., tee-times are reserved), the changes are transmitted through internet 20 (e.g., through an HTTP Web Services Protocol) to data server 16. The golf facilities, through the interfaces or software provided, supply only tee-time information to data server 16, not reservation data or any related information. Because of the software or interface supplied by the owner/operator of tee-sheet provider 12 to each golf facility, all communications take place through common software, thereby obviating the need to have to interpret or decode data sent from data server 16.

As explained above, the complete library of participating golf facilities and available times is current and live. A golfer/user logging onto web site 14 can browse the search engine library at any convenient time and select a desired course, as illustrated by the screen or window in FIG. 2. Here it will be understood that, depending upon the size of golf course tee-time management system 10, golf courses may be separated by regions, states, cities, or areas within any of these. The golfer/user then selects a desired date to play, as illustrated in the screen or window of FIG. 3. A third screen or window of FIG. 4 is then available showing the tee-time sheet and the golfer/user can pick a desired tee-time from the tee-times listed as currently available. Once a desired tee-time is selected, web site 14 has windows for purchasing (or reserving) the specific tee-time selected. As is understood by internet users, this generally consists of supplying a credit card and the necessary information. A booking request is communicated by data server 16 to the selected golf facility to complete the transaction. Generally, a confirmation code will be transmitted through data server 16 to the remote PC of the golfer/user and a voucher can be printed by the golfer/user at their remote PC to be used as proof of payment for the scheduled tee-time.

Thus, a golf course tee-time management system has been disclosed that is simple to operate and use. Any number of golf facilities (golf courses) can be incorporated into the system and, because of the simplicity of the system, can still conduct business normally without interruption. A golfer/user desiring to reserve a tee-time can log onto the web site from an available remote PC at their home, office, etc. and browse the various golf courses to select a desired course. Tee-times can be easily reserved, paid for, and a voucher printed in the same operation. Further, the operation can be performed at any time (day or night) convenient to the user in the convenience of their home, office, etc.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A golf course tee-time management system comprising:
a data server coupled through the internet to a plurality of participating golf facilities, each participating golf facility having interface software coupling the participating golf facility to the data server, the data server and the interface software being designed to provide tee-sheets in real time for each of the plurality of participating golf facilities;
a web site coupled to the data server and having associated software for displaying information on a remote PC about each of the plurality of participating golf facilities and the tee-sheets of each of the plurality of participating golf facilities including available tee-times.

2. A golf course tee-time management system as claimed in claim 1 wherein the web server includes software for collecting and housing uploaded data from all participating golf facilities.

3. A golf course tee-time management system as claimed in claim 1 wherein one of the web server and the web site includes software for receiving payment for a tee-time from a user.

4. A golf course tee-time management system as claimed in claim 3 wherein the web server is coupled to notify the golf facility of a completed reservation for the tee-time and supply a printable voucher to the user.

5. A method of operating a golf course tee-time management system comprising the step of:
subscribing a plurality of participating golf facilities to the management system;
providing each participating golf facility with interface software;
providing a data server and coupling the plurality of participating golf facilities to the data server through the internet and the interface software;
providing a web site coupled to the data server and available to PCs through the internet;
communicating tee-sheets in real time from each of the participating golf facilities to the data server through the interface software at each participating golf facility; and
displaying on a remote PC on demand from the remote PC tee-time availability at any selected participating golf facility.

6. A method as claimed in claim 5 including a step of confirming a tee-time selection at the participating golf facility by the remote PC user.

7. A method as claimed in claim 6 wherein the step of confirming a tee-time selection at the participating golf facility by the remote PC user includes supplying a printable voucher to the user.

8. A method as claimed in claim 5 further including the steps of:
logging onto the web site using a remote PC;
brousing the web site and selecting a desired golf facility from the plurality of participating facilities;
selecting a desired date to play golf at the selected participating golf facility;
displaying available tee-times at the selected participating golf facility and selecting a specific available tee-time; and
paying for the selected tee-time through the web site.

9. The method of claim 8 including a step of displaying a voucher indicating the payment and tee-time and printing a copy of the voucher from the remote PC.

10. A method of remotely reserving golf course tee-times comprising the steps of:
subscribing a plurality of participating golf facilities to the management system;
providing each participating golf facility with interface software;
providing a data server and coupling the plurality of participating golf facilities to the data server through the internet and the interface software;
providing a web site coupled to the data server and available to PCs through the internet;
communicating tee-sheets in real time from each of the participating golf facilities to the data server through the interface software at each participating golf facility;
displaying on a remote PC in response to demand from the remote PC, tee-time availability at any selected participating golf facility; and
confirming a tee-time selection at the participating golf facility by the remote PC user including supplying a printable voucher to the user.
